(19) United States
(12) Patent Application Publication
(10) Pub. No.: US 2002/0168989 A1
(43) Pub. Date: Nov. 14, 2002

(54) Method of determining position in a cellular communications network

(75) Inventors: Saul R. Dooley, Reigate (GB); Said Moridi, London (GB); Domenico G. Porcino, Horley (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/109,773

(22) Filed: Mar. 29, 2002

(30) Foreign Application Priority Data
Mar. 30, 2001 (GB) 0107949.0

(51) Int. Cl. H04Q 7/20

(52) U.S. Cl. 455/456; 455/457

(57) ABSTRACT

A time-of arrival(TOA) method of determining the position of a cellular handset, for example a phone or a PDA, comprises causing the wireless terminal (MWT) to adapt to operate on a first network (GSM) having a plurality of first base stations (GSM 1 to GSM 3) and effecting position measurements with respect to ranging signals transmitted by one or more of the first base stations and causing the wireless terminal to adapt to operate on a second network (UMTS) having a plurality of second base stations (UMTS 1 to UMTS 3) and effecting position measurements with respect to ranging signals transmitted by one or more of the second base stations. The position measurements are combined and the position of the wireless terminal is determined from the combined measurements. The position fix may be determined by the wireless terminal (MWT) or a remote station to which the position measurements are relayed by the wireless terminal.

The present invention relates to a method of determining position in a cellular communications network which relies on a mobile wireless terminal determining its position on the basis of time of arrival (TOA) measurements on ranging signals transmitted by several base stations whose geographical positions or their antenna positions are known accurately. Such a method is generally referred in the art as cellular positioning.

The use of TOA as a means of determining position is not new in itself. To obtain a reliable position fix, the mobile wireless terminal should be able to receive good quality signals from at least 3 base stations. In a typical cellular network, the probability of receiving three or more signals from distinct base stations is low in many conditions (for example in rural areas or urban canyons). Even when reception of three separate signals is possible, some of them will arrive at the mobile wireless terminal (or handset) severely attenuated, especially in urban areas, and, because a minimum of three signals is required, it is not possible to select the best measurements and discard the less reliable ones. As a result each TOA measurement is likely to have a different reliability.

One method of improving the reliability of TOA measurements is disclosed in U.S. Pat. Specification No. 5,999,124 in which a combination of TOA measurements of GPS satellites and measurements from cellular network ranging signals are used to improve the calculation of the positions by mobile wireless terminal. The use of GPS satellites is acceptable in open areas where mobile wireless terminals can receive good quality radio signals but is less acceptable in urban areas or indoors where buildings or walls may block or attenuate signals from satellites.

It is an object of the present invention to improve the reliability of determining the position of a mobile wireless terminal and the accuracy of the estimates when using TOA techniques.

According to one aspect of the present invention there is provided a method of determining the position of a mobile wireless terminal, comprising causing the wireless terminal to adapt to operate on a first network having a plurality of first base stations and effecting position measurements with respect to one or more of the first base stations, causing the wireless terminal to adapt to operate on a second network having a plurality of second base stations and effecting position measurements with respect to one or more of the second base stations, combining the position measurements obtained and determining the position of the wireless terminal from the combined measurements.

According to another aspect of the present invention there is provided a cellular communications system comprising a first network consisting of geographically distributed first base stations, a second network consisting of geographically distributed second base stations and at least one mobile wireless terminal comprising means for receiving wireless signals from the first network and from the second network, means for alternatively selecting signals received from the first and second networks and time of arrival (TOA) determining means for determining the position of the terminal from the signals selected.

According to a further aspect of the present invention there is provided a mobile wireless terminal comprising means for receiving wireless signals from a first network and from a second network, means for alternatively selecting signals received from the first and second networks and time of arrival (TOA) determining means for determining the position of the terminal from the signals selected.

By being able to access at least two networks, it is possible to obtain multiple TOA measurements, that is three or more measurements, and to assign an indication of confidence or weight to each one. Thus when carrying out cellular positioning, the wireless terminal can select the best k measurements, where k is equal to or greater than 3. Another benefit of the method in accordance with the present invention is that it is possible to obtain a position fix by cellular positioning in situations where a network has insufficient base stations for a position fix to be determined. A further benefit of having multiple TOA measurements is that the system can be improved using space diversity, that is, the fact that the multipath will come from different paths and can be averaged out, or frequency diversity when the two networks are operating in different bands.

In one embodiment of the present invention the mobile wireless terminal is a multimode, for example dual band, terminal capable of operating on several types of cellular systems, for example GSM and UMTS 3G FDD mode or IMT-DS (in the UK), IS-95 and IS-136 (in the USA), GSM and cdma 2000 (in South America) and PHS and W-CDMA in the Far East. In the case of GSM and UMTS, GSM base stations are unsynchronised and a technique termed Enhanced Observed-Time-Difference (E-OTD) is required. E-OTD entails receiving timing offset information requested from a respective base station in addition to a ranging signal. A benefit of using a multi-mode mobile wireless terminal for positioning using a plurality of networks is that no additional hardware has to be incorporated into the terminal. Additionally it is estimated that even in a fully-deployed UMTS 3G FDD mode or IMT-DS network, a UMTS receiver will not see more than 2 base stations 12% of the time and hence will be unable to determine its position using the UMTS network alone. By being able to obtain positioning information from a second network, such as GSM, a complete location service can be offered.

In another embodiment of the present invention the first and second networks operate in accordance with the same standard.

If desired the measurements may be transmitted to a remote station which combines these measurements and determines the position of the wireless terminal. Optionally the remote station may transmit the position determined to the wireless terminal.

The present invention will now be described, by way of example, with reference to the accompanying drawings, wherein:

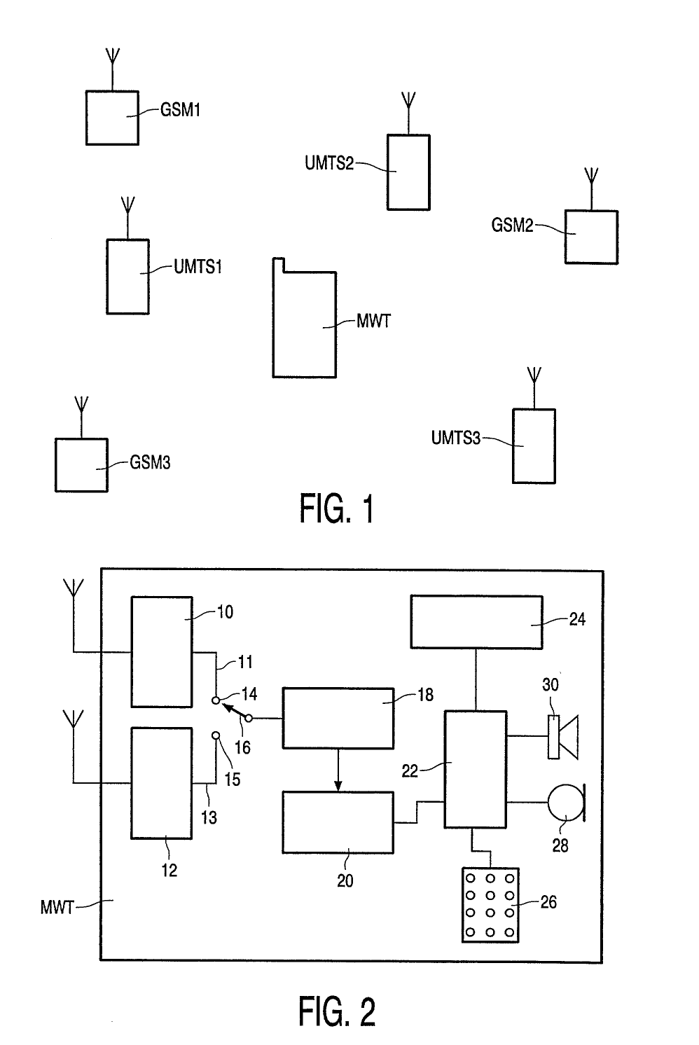

FIG. 1 is a block schematic diagram of a dual band cellular telephone system,

FIG. 2 is a block schematic diagram of a dual band GSM-UMTS phone, and

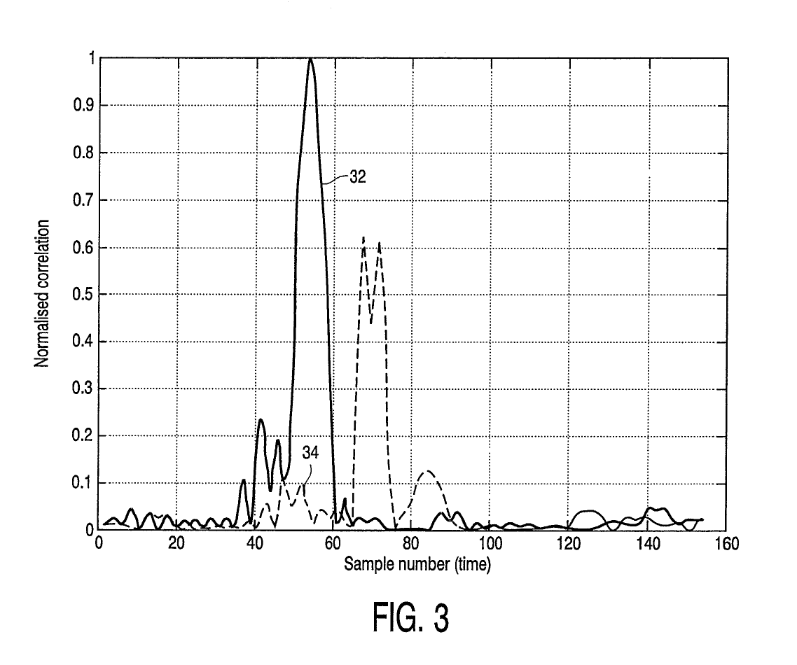

FIG. 3 is a graph showing the correlation functions for dual mode receivers, the abscissa is calibrated in sample number (time) and the ordinate represents the Normalised Correlation.

In the drawings the same reference numerals have been used to indicate corresponding features.

The dual band cellular telephone system shown in FIG. 1 comprises a first network comprising three geographically distributed GSM base stations GSM 1, GSM 2 and GSM 3 and a second network comprising three geographically distributed UMTS 3G FDD or IMT-DS base stations UMTS 1, UMTS 2 and UMTS 3. A plurality of dual band mobile wireless terminals, for example cellular telephones, PDAs or other devices capable of communicating on the system, of which one terminal MWT is shown are able to roam into and out of the radio coverage areas of the respective base stations. The base stations of each particular system are coupled, for example by landlines, to a system controller (not shown) which controls the operation of the network so formed. Each of the base stations GSM 1 to GSM 3 and UMTS 1 to UMTS 3 comprises a radio transceiver and a controller.

In order for a mobile wireless terminal MWT to be able to determine its position using time of arrival (TOA) measurements, the respective base stations transmit ranging signals. The ranging signals may include details of the location of each base station or of its transmitting antenna if it is not cosited with the base station. The base station location may be obtained from a different source if required, from MWT's own data base or a remote data base. The terminal MWT analyses the ranging signals in order to make Time-Difference-of-Arrival (TDOA) measurements. The GSM base stations are unsynchronised and a technique known as Enhanced—Observed-Time-Difference (E-OTD) is required. This technique requires the terminal MWT requesting the base station GSM 1, GSM 2 or GSM 3 to supply timing offset information in addition to the ranging signal.

Using one of the cellular systems, that is GSM or UMTS, on a dual band terminal MWT requires reliable TOA measurements from at least 3 base stations. However in urban areas the ranging signals may arrive severely attenuated and also the reliability of say the respective GSM measurements may be different. In the case of UMTS it is estimated that a terminal MWT will not see more than 2 base stations 12% of the time.

In order to be able to obtain a dependable location determination, the dual band terminal MWT makes use of both the GSM and UMTS systems.

FIG. 2 illustrates a block schematic diagram of a GSM/UMTS mobile wireless terminal MWT. The terminal comprises a UMTS transceiver 10 and a GSM transceiver 12 having outputs 11, 13 coupled to respective terminals 14, 15 of a change-over switch 16. Ranging signals from the selected transceiver 10 or 12 are applied to a TOA estimator 18. The timing estimates are then relayed to a positioning algorithm stage 20 which determines the location of the terminal MWT. The results are passed to a controller 22 which controls the operation of the terminal in accordance with pre-stored software. A LCD screen 24 is coupled to the controller 22 and may be used to display the position of the terminal MWT. Also coupled to the controller 22 are a keypad 26, a microphone 28 and a loudspeaker 30.

In the case of GSM ranging signals the TOA estimator 18 makes GSM E-OTD positioning measurements and when switched to the UMTS transceiver 10 it makes UMTS TDOA measurements. Relative time difference removal may be carried out in the receivers 10 and 12.

The position algorithm stage 20 combines some or all of the E-OTD and TDOA measurements, which may be grouped or ordered in accordance with a suitable statistical algorithm, for example histograms, or may be weighted individually so that unreliable or less reliable measurements are weighted less or discarded. Also by being able to use more in range base stations the position fix algorithm will yield more accurate results.

Although the terminal MWT makes the TOA measurements and subtracts the observed time offsets via the E-OTD method, the positioning algorithm will involve differencing the TOA measurements to remove the common timing error due to the MWT's oscillator offset.

In the event that pairs of the GSM and UMTS base stations are co-located, for example GSM 1 and UMTS 1, GSM 2 and UMTS 2 and GSM 3 and UMT 3, then frequency diversity can help in combining the separate timing estimations. As an example GSM networks operate at 900 MHz or 1800 MHz and the propagation characteristics are different from UMTS downlink at 2100 MHz. Even if the TOA estimation provides the same range, the signal with the higher reliability, for example largest signal-to-noise ratio (SNR) can be selected. FIG. 3 illustrates in full lines a GSM TOA estimation 32 and in broken lines a UMTS signal 34. In the area of sample 50 it will be noted that the GSM TOA estimation has a clearly defined peak whereas the UMTS signal is noisy, weak and the peak is ill defined. Accordingly the GSM TOA estimation 32 has the largest SNR and can be chosen with confidence.

FIG. 3 can also be used to illustrate a non-line-of-sight measurement from one base station, curve 34, versus a clear measurement, curve 32, from another base station in the case of spatial diversity in which the base stations are not co-located and the multipath characteristics can be completely different.

In practice a dual band MWT in UMTS mode takes ranging measurements from say 2 UMTS base stations and then switches to GSM mode and takes ranging measurements from 4 GSM base stations. Considering TDOAs, there will be 6 TDOA measurements which can be passed from the TOA estimator 18 (FIG. 2) to the triangulation algorithm stage 20 (FIG. 2). This results in more measurements than would be available from using GSM or UMTS alone and as a result the positioning will be more accurate because it is based on the better measurements.

By being able to select the better measurements, a marked improvement of the position estimate is obtained. By way of example the following results were obtained in exactly the same conditions for different urban areas and using exactly the same algorithms. Inputs were received from only 3 base stations from one network and 7 base stations from another network and the following weighting is applied—the lower error the figure the better

Errors (in metres, 67% cases)

| | Signals from | 7 Base Stations |
|---|---|---|
| | 3 Base Stations | (weighted) on at least |
| | on same network | 2 networks |
| Urban A | 92 metres | 70 metres |
| Urban B | 83 metres | 36 metres |
| Bad Urban | 156 metres | 96 metres |

By selecting the better measurements, an improvement of over 100% in the accuracy can be obtained in some cases.

In a non-illustrated variant of the embodiment shown in FIGS. 1 and 2, the base stations of the first and second networks operate in accordance with the same standard for example GSM or UMTS. In order to save the operator of each of the first and second networks having to install more base stations for TDOA positioning than are necessary for normal speech and data operations, the operators have agreement whereby the mobile wireless terminals are provided with the necessary software to enable them to recover downlink ranging information signals including the location of their base stations not only from their own network but also from at least one other competing network having base stations in the same locality. As the locations of the base stations from which TOA measurements are made is essential, any convenient means to download this information, for example a small neighbouring database may be used. Thus the mobile wireless terminal and/or a base station is able to compute its position on the basis of the best available signals from at least 2 networks.

If the mobile wireless terminal is designed for operation in accordance with a single standard then it will have a single transceiver rather than two transceivers as shown in FIG. 2.

For convenience of description, the mobile wireless terminal has been described in the context of being able to operate in a single band or dual band. However the teachings of the present invention can be applied to multiple-bands and multiple standards.

If desired an operator and/or service provider may charge a premium on these terminals which are capable of receiving ranging information from a network or networks beside its own network.

Optionally the position fix may be done in one of the base stations or a remote station. In such a case, the base station may include means, such as sector antennas, for making angle of arrival (AOA) measurements. Once the position fix has been determined, it can be relayed to the mobile wireless terminal. Optionally the base station or remote station making the position fix may make its own TOA, TDOA or AOA measurements pertaining to the wireless terminal and combine these measurements with those made by the wireless terminal in order to calculate the position fix.

1. A method of determining the position of a mobile wireless terminal, comprising causing the wireless terminal to adapt to operate on a first network having a plurality of first base stations and effecting position measurements with respect to one or more of the first base stations, causing the wireless terminal to adapt to operate on a second network having a plurality of second base stations and effecting position measurements with respect to one or more of the second base stations, combining the position measurements obtained and determining the position of the wireless terminal from the combined measurements.

2. A method as claimed in claim 1, characterised in that the measurements are Enhanced Observed Time Difference (E-OTD).

3. A method as claimed in claim 1 or 2, characterised in that the measurements are Time Difference Of Arrival (TDOA).

4. A method as claimed in claim 1, 2 or 3, characterised in that the position measurements are weighted when combined.

5. A method as claimed in any one of claims 1 to 4, characterised in that angle of arrival (AOA) measurements are used, optionally combined with TOA or TDOA measurements, to determine the position of the wireless terminal.

6. A method as claimed in claim 5, characterised by the mobile terminal transmitting the position measurements made with respect to the first and second base stations to a remote station, in that the remote station combines the position measurements, and in that the remote station determines the position of the wireless terminal from the combined measurements.

7. A method as claimed in claim 6, characterised by the remote station transmitting the position of the wireless terminal to the wireless terminal.

8. A method as claimed in claim 5, 6 or 7, characterised by the remote station making TOA, TDOA or AOA measurements pertaining to the position of the wireless terminal and by combining these measurements with the measurements made by the wireless terminal in order to calculate the position of the wireless terminal.

9. A method as claimed in any one of claims 1 to 8, characterised in that the first and second networks operate in accordance with different standards.

10. A cellular communications system comprising a first network consisting of geographically distributed first base stations, a second network consisting of geographically distributed second base stations and at least one mobile wireless terminal comprising means for receiving wireless signals from the first network and from the second network, means for alternatively selecting signals received from the first and second networks and time of arrival (TOA) determining means for determining the position of the terminal from the signals selected.

11. A system as claimed in claim 10, characterised in that the first and second networks operate in accordance with different standards.

12. A mobile wireless terminal comprising means for receiving wireless signals from a first network and from a second network, means for alternatively selecting signals received from the first and second networks and time of arrival (TOA) determining means for determining the position of the terminal from the signals selected.

13. A terminal as claimed in claim 12, characterised in that the receiving means includes means for removing relative time difference and the TOA determining means comprises a TOA estimator and a positioning algorithm stage.

14. A terminal as claimed in claim 13, characterised in that weighting means are provided for weighting the output from the TOA estimator on the basis of the less reliable the signal, the lower the weighting function.
